(19) United States
(12) Patent Application Publication
(10) Pub. No.: US 2026/0135710 A1
(43) Pub. Date: May 14, 2026

(54) AUTHENTICATION OF A USER VIA A PRIVATE-NETWORK IDENTITY SERVICE

(71) Applicant: Tailscale Inc., Toronto (CA)

(72) Inventors: Bradley J. Fitzpatrick, Seattle, WA (US); Maisem J. Ali, Woodinville, WA (US)

(21) Appl. No.: 19/388,864

(22) Filed: Nov. 13, 2025

Related U.S. Application Data
(60) Provisional application No. 63/720,058, filed on Nov. 13, 2024.

(51) Int. Cl. H04L 9/32; H04L 9/40

(52) U.S. Cl. CPC H04L 9/3213; H04L 63/0428; H04L 63/10

(57) ABSTRACT

The technology disclosed herein enables reliance on private network security by an identity provider when handling access-token requests. In a particular example, a method includes authenticating a node of a user to access the private network. The method further includes transmitting an access request from the node to a resource and receiving, at the node, a request from the resource for a token validating an identity of the user. The method also includes, at the node, requesting the token from the identity provider over the private network. The identity provider provides the token to the node on a basis of the node having access to the private network. Additionally, the method includes transmitting the token from the node to the resource, wherein the resource provides the node with access thereto upon confirming with the identity provider that the token is valid.

### RELATED APPLICATION

This application is related to and claims priority to U.S. Provisional Patent Application 63/720,058, titled “AUTHENTICATION OF A USER TO EXTERNAL SYSTEMS FROM A PRIVATENETWORK IDENTITY SERVICE,” filed November 13, 2024, and which is hereby incorporated by reference in its entirety.

### BACKGROUND

Identity providers (IDPs) are widely used to manage authentication and authorization across applications and services. An IDP typically validates user credentials and issues tokens or assertions that allow users to access protected resources. This approach simplifies identity management and enables single sign-on (SSO) across multiple systems. Conventional IDP implementations often rely on centralized or cloud-based architectures and may require repeated credential entry or multi-factor authentication when accessing different applications.

Private networks, such as virtual private networks (VPNs) or overlay networks, also enforce strong authentication during the process of joining the network. These networks ensure that only trusted nodes can participate and provide secure communication channels between authorized devices. Despite this, applications and services—whether internal or external to the network—frequently implement separate authentication workflows, resulting in redundant credential prompts and additional complexity for users and administrators.

### SUMMARY

The technology disclosed herein enables reliance on private network security by an identity provider when handling access-token requests. In a particular example, a method includes authenticating a node of a user to access the private network. The method further includes transmitting an access request from the node to a resource and receiving, at the node, a request from the resource for a token validating an identity of the user. The method also includes, at the node, requesting the token from the identity provider over the private network. The identity provider provides the token to the node on a basis of the node having access to the private network. Additionally, the method includes transmitting the token from the node to the resource, wherein the resource provides the node with access thereto upon confirming with the identity provider that the token is valid.

In another example, an identity-provider system is provided having one or more computer readable storage media and one or more processing systems operatively coupled with the one or more computer readable storage media. Program instructions stored on the one or more computer readable storage media, when read and executed by the one or more processing systems, direct the identity-provider system to join the identity-provider system to the private network and receive a token request from a node over the private network. The token request is for a token validating a user of the node. The program instructions further direct the identity-provider system to determine the token should be provided to the node based on the node being on the private network and transmit the token to the node over the private network. The node uses the token to access a resource.

In a further example, a method includes authenticating a node of a user to access the private network and transmitting an access request from the node to an external system. The external system is external to the private network and is configured to use the identity provider to validate user identities. The method also includes receiving, at the node, a request from the external system for a token validating an identity of the user and, at the node, requesting the token from the identity provider over the private network. At the identity provider, the method includes providing the token to the node on a basis of the user having already been authenticated for the node to access the private network. The method further includes transmitting the token from the node to the external system. The external system provides access to the node upon confirming with the identity provider that the token is valid.

### BRIEF DESCRIPTION OF THE DRAWINGS

FIGS. 1 illustrates an implementation for authenticating a user to a resource using a private-network identity service.

FIG. 2 illustrates an operation to authenticate a user to a resource using a private-network identity service.

FIG. 3 illustrates an operational scenario for authenticating a user to a resource using a private-network identity service.

FIGS. 4 illustrates an implementation for authenticating a user to a resource using a private-network identity service.

FIG. 5 illustrates an operational scenario for authenticating a user to a resource using a private-network identity service.

FIG. 6 illustrates an operational scenario for authenticating a user to a resource using a private-network identity service.

FIG. 7 illustrates a computing system for authenticating a user to a resource using a private-network identity service.

### DETAILED DESCRIPTION

An Identity Provider (IDP) is often used as a key component in an authentication process. An IDP may be responsible for validating user identities and providing the necessary credentials or tokens for users to access protected systems and services. In an example, the authentication process begins when a user attempts to access a resource or application (e.g., a Service Provider) that requires authentication. The resource redirects the user to the IDP, requesting an authentication assertion, which is used to prove the user’s identity. This request may contain information such as the type of authentication needed (e.g., password or multi-factor authentication), the resource the user is trying to access, and any additional attributes required for access control, such as user roles or permissions.

Upon receiving the authentication request, the IDP prompts the user for their credentials, typically a username and password. If multi-factor authentication (MFA) is required, the IDP will request a second factor, such as an OTP (one-time passcode), biometric data (e.g., fingerprint or facial recognition), or a hardware security key. After the user provides the requested information, the IDP verifies the user’s identity by checking the provided credentials against its authentication database, such as LDAP, Active Directory, or a cloud-based identity store like Okta.

Once the user is authenticated, the IDP generates an authentication token or assertion that contains the user’s identity attributes (e.g., user ID, roles, and permissions). This token is signed by the IDP to ensure its integrity and authenticity. The token is then sent to the resource. Upon receiving the token, the resource validates the token by verifying the token’s signature (and possibly checking for expiration and/or ensuring the user has the necessary attributes for access). If the token is valid and the user is authorized, access to the requested resource is granted.

Once authenticated, the user may be able to use the token for ongoing access to the resource without needing to re-authenticate. In some cases, Single Sign-On (SSO) may be enabled, allowing the user to access multiple resources, sometimes from different service providers, with a single authentication event. The session or access token is typically stored on the client side (in a cookie, local storage, or session storage) for future use. In some cases, the IDP may also support federated authentication, allowing users to authenticate across multiple domains or organizations that have established trust relationships. This enables cross-domain access to services without the need for separate logins, using standards like Security Assertion Markup Language (SAML), OAuth 2.0, or OpenID Connect (OIDC) for secure identity federation.

In many cases, a resource is not configured to accept tokens from a particular IDP. A different form of authentication will be necessary to access the resource in those examples. Thus, while a user may have already authenticated themselves with the IDP, the user will have to authenticate themselves again to the resource. The identity providers described below within a private network rely on a user already being authenticated to the private network to determine the user can also be authenticated to resources external to the private network. An external resource can, therefore, be configured to use the IDPs to authenticate a user rather than the user having to again provide authentication credentials to the external resource. This approach enables an authentication experience where users authenticated to the private network do not need to re-enter credentials or perform multi-factor authentication (MFA) for applications. By leveraging cryptographic device identity established during private network enrollment, the system mitigates MFA fatigue attacks and reduces friction while maintaining strong security guarantees.

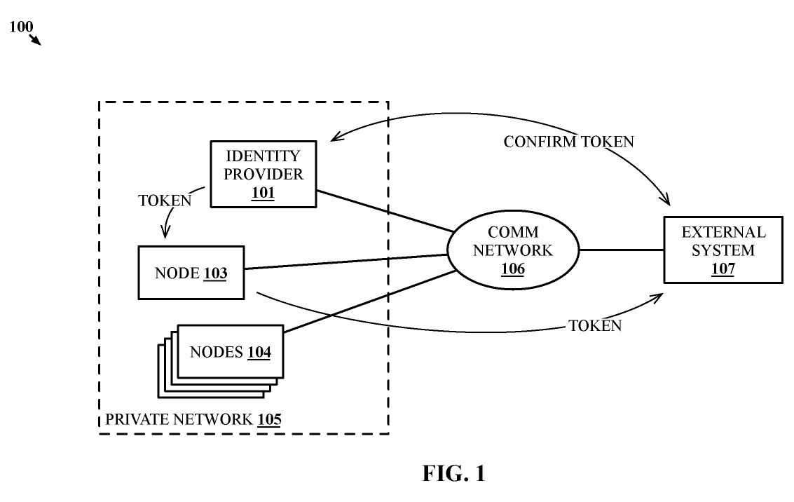

FIGS. 1 illustrates implementation 100 for authenticating a user to a resource using a private-network identity service. Implementation 100 includes identity provider 101, node 103, nodes 104, communication network 106, and external system 107. Identity provider 101 and nodes 103-104 communicate with each other over private network 105. Private network 105 is a private network, such as a Virtual Private Network (VPN) or a physical private network, that uses an authentication mechanism, such as an IDP, to ensure computing devices connected to private network 105 are authorized to join private network 105. Private network 105 is an overlay network on physical networking hardware, such wired/wireless communication links, routers, switches, firewalls, computing devices, or other type of components for providing network communications between computing systems. In some examples, at least a portion of the physical networking hardware is included in, or underlies a portion of, communication network 106. Communication network 106 may include one or more local area networks, wide area networks (e.g., the Internet), or some other type of network. External system 107 is a resource that provides a computing service/application over communication network 106. External system 107 may provide an application, data storage, or some other type of resource that may be accessible over a network like communication network 106. External system 107 may include one or more computing devices (physical and/or virtual), such as servers, to provide the service. While external system 107 is not a node on private network 105, resources may be provided by systems that are nodes on private network 105 in other examples.

In operation, users of computing devices (e.g., personal computers, laptops, smartphones, tablets, servers, virtual machines, or other type of computing devices – including combinations thereof) authenticate themselves to private network 105 enabling the computing devices to connect to private network 105 as nodes 103-104 and exchange communications with each other over private network 105. Private network 105 may leverage an external system, such as an IDP, to authenticate users, may use an internal authentication mechanism, or may use some other mechanism for ensuring a computing device is associated with a user authorized to access private network 105. For instance, identity provider 101 may federate with external identity providers (e.g., Google, Okta, Microsoft Entra ID) during initial node enrollment. This allows the system to inherit trust from enterprise identity systems while providing a unified authentication experience for applications accessible by nodes in private network 105. Devices of users that are unable to authenticate themselves to private network 105 (or are otherwise not allowed to access private network 105) are not allowed to join private network 105 as nodes to private network 105.

In cases where private network 105 is a VPN, an overlay network is achieved through a process called encapsulation, where the data packets sent between devices (e.g., from one private IP address on the private network to another) are wrapped inside additional packets that include encrypted information. For instance, when a VPN endpoint device (e.g., device of nodes 103-104) sends data through a VPN, a packet carrying the data is encrypted and then encapsulated with a new packet header that includes a public IP address corresponding to the private IP address of another VPN endpoint device as the destination. This encapsulated packet is then sent over a public network to the destination VPN endpoint device.

At the destination VPN endpoint device, the outer packet header is stripped away to reveal the original encrypted packet. The original packet is then decrypted, allowing the data to be processed by the device. In some examples, the VPN endpoint device may be a VPN server operating as a gateway to the public network. In those examples, the decrypted original packet may be transmitted to a destination IP address on the public network identified in a header of the original packet. The above encryption method ensures that the data remains confidential and secure as it travels over potentially insecure networks, as only the VPN destination endpoint can decrypt and access the original information. By creating a secure tunnel through encryption and encapsulation, VPNs effectively simulate a private network over a public infrastructure, providing privacy and security for users. As such, a communication received by a node over the VPN can be trusted to have been sent by another node authorized to access the VPN.

Identity provider 101 relies on that trust to provide authentication tokens to services outside of private network 105. If identity provider 101 receives a request to provide a token over private network 105, the trust enables identity provider 101 to assume the requesting node is authorized to access private network 105. An authentication token is generated and provided to the requesting node in response to the request. When the token is provided to an external resource by the node, identity provider 101 can confirm the token is valid to enable provision of a service to the node by the external resource.

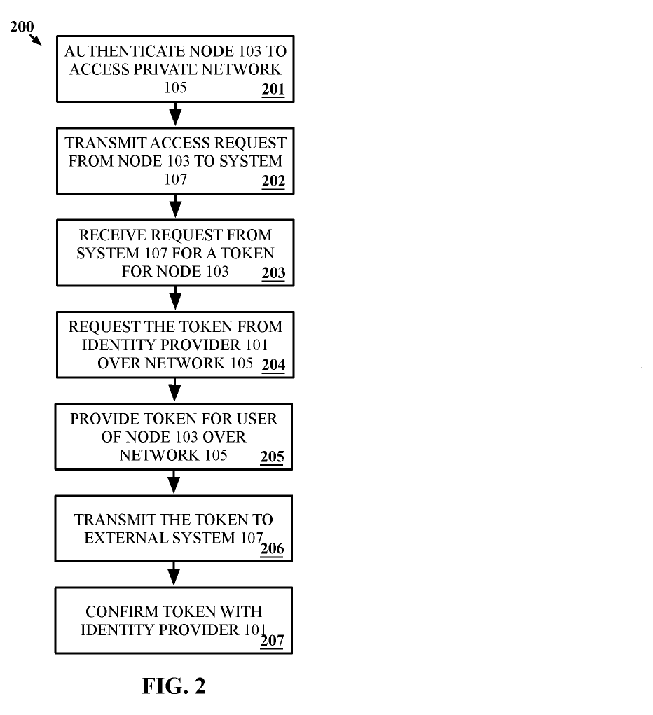

FIG. 2 illustrates operation 200 to authenticate a user to a resource using a private-network identity service. Operation 200 is an example of identity provider 101 authenticating node 103 for access to the external system 107 resource. Node 103 is authenticated to access private network 105 (step 201). Node 103 may authenticate itself by providing credentials of an authorized user to private network 105 or an identity provider associated therewith. Upon being authenticated for access to private network 105, private network 105 provides node 103 with network information (e.g., Internet Protocol (IP) addresses, encryption keys, etc.) necessary to securely exchange communications with nodes 104 over private network 105. A software process (e.g., client or agent) executing on node 103 may control node 103 to handle authentication to private network 105 and communications transmitted over private network 105 (e.g., may handle encapsulation of packets for transmission). Other nodes, including identity provider 101, may also execute such a software process to facilitate their connections to private network 105. Identity provider 101 may provide credentials of an administrator of private network 105 or some other credentials recognized as being allowed to access private network 105.

After being authenticated for access to private network 105, node 103 transmits an access request to external system 107 (step 202). External system 107 is a resource (e.g., application or service) that identity provider 101 intends to access. External system 107 is configured to use identity provider 101 to authenticate nodes within private network 105. For instance, external system 107 may recognize the request is received from a domain of private network 105 and determine identity provider 101 should be used on the request. Requests received from domains other than those of private network 105 may be configured to use other identity providers or some other authentication mechanism. After sending the access request, node 103 receives a token request from external system 107 requesting that node 103 provide an authentication token to external system 107 (step 203). The token request and subsequent token-related exchanges described below may occur in a standard protocol, such as SAML or OAuth, or may use some other type of protocol understood by identity provider 101, nodes 103-104, and external system 107. When using OIDC, identity provider 101 may expose a discovery document at a node in private network 105 designated as a well-known endpoint that specifies the authorization_endpoint, token_endpoint, userinfo_endpoint, and jwks_uri. Applications use this metadata to initiate the standard OAuth 2.0 authorization code flow, enabling interoperability with existing OIDC clients.

In response to the token request, node 103 requests a token from identity provider 101 over private network 105 (step 204). Identity provider 101 is a node on private network 105. Identity provider 101 may be a computing device (or virtual machine) dedicated to operating as an IDP, may be a process executing on a multi-function computing device (or virtual machine), or may be distributed across multiple nodes connected to private network 105. In some examples, identity provider 101 may operate as an OpenID Connect (OIDC) server embedded within private network 105 using a networking library. This allows identity provider 101 to join private network 105 as a node without requiring separate infrastructure, enabling direct communication with other nodes and simplifying deployment. Node 103 may be preconfigured to request a token from identity provider 101 upon receiving a token request from external system 107 or the token request may instruct node 103 to contact identity provider 101. In an example of the latter, the token request may be a redirect message directing node 103 to identity provider 101.

In response to receiving the request from node 103, identity provider 101 provides an authentication token to node 103 over private network 105 (step 205). The token may be generated from attributes of node 103 and/or the user of node 103 (e.g., a hash function may take the attributes as input and provide the token as output), may be a string of random characters unique to node 103 and/or the specific request from node 103, or may be some other piece of information that node 103 can use to prove its identity to external system 107. In some examples, the token may include claims representing user and/or device identity, such as node public key, name of private network 105, and assigned IP addresses. These claims enable applications, such as that provided by external system 107, to enforce fine-grained access policies based on device posture and network membership. In some examples, the token may be unique for private network 105 as a whole. For instance, external system 107 may be configured to provide access to any node on private network 105 regardless of user. In those cases, external system 107 may require a token for private network 105 as a whole not an individual node of private network 105.

Upon receiving the token from identity provider 101, node 103 transmits the token to external system 107 in response to the token request from external system 107 (step 206). In response to receiving the token, external system 107 confirms the token is valid with identity provider 101 (step 207). External system 107 may transmit the token to identity provider 101 and receive a response from identity provider 101 indicating the token matches the token identity provider 101 generated for node 103. In some examples, identity provider 101 may include a signature when providing the token to node 103. External system 107 receives that signature from node 103 with the token and external system 107 expects a response from identity provider 101 to include the same signature to ensure the token is valid. If the token (and signature in examples having a signature) is valid, then external system 107 provides the access requested by node 103. Otherwise, access is denied.

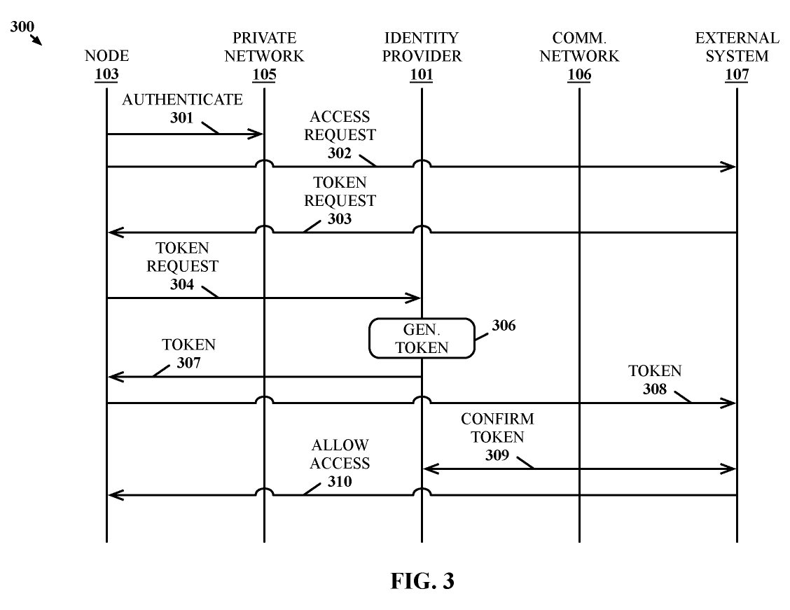

FIG. 3 illustrates operational scenario 300 for authenticating a user to a resource using a private-network identity service. Operational scenario 300 is an example similar to operation 200 showing which networks are used for which communications. Specifically, private network 105 authenticates the user of node 103 to enable node 103 to connect to private network 105 (step 301). In some examples, node 103 may connect to an existing node of private network 105 over communication network 106 to authenticate itself and receive network information necessary for communicating over private network 105. Regardless of how node 103 authenticates itself to private network 105, after the authentication, node 103 determines it requires access to external system 107 (e.g., the user of node 103 may direct node 103 to connect to external system 107 or a process executing on node 103 may direct node 103 to request access). An access request is sent to external system 107 (step 302). In response to the access request, external system 107 requests a token from node 103 (step 303). Since external system 107 is not a node on private network 105, the access request and token request (along with any other communications exchanged between node 103 and external system 107) are exchanged over communication network 106. While the access request and token request are shown being exchanged directly between node 103 and communication network 106, the requests may pass through another node on private network 105 in some examples. For instance, an exit node may be configured to handle communications between node 103 and systems external to private network 105. Thus, to reach communication network 106, communications from node 103 may be directed through another node of private network 105.

Upon receiving the token request from external system 107, node 103 transmits its own token request to identity provider 101 (step 304). This token request is transmitted over private network 105. By virtue of the token request being received from node 103 over private network 105, identity provider 101 knows node 103 is at least authenticated for the purposes of communicating over private network 105. As such, identity provider 101 generates a token for node 103 to use to authenticate itself to external system 107 (step 306). If the token request was not received over private network 105, then identity provider 101 cannot assume the requesting node is authenticated and, therefore, would not generate the token. In some cases, identity provider 101 may simply not receive or discard requests coming from networks other than private network 105. Identity provider 101 transmits the generated token to node 103 over private network 105 (step 307). Upon receiving the token, node 103 transmits the token to external system 107 over communication network 106 (step 308).

Prior to granting node 103 access, external system 107 confirms with identity provider 101 that the token is valid (step 309). Since external system 107 is not a node of private network 105, the communications for the confirmation are exchanged over communication network 106. Like node 103, communications between identity provider and systems on communication network 106 may pass through another node of private network 105, such as a designated exit node. 101 External system 107 may use a signature with the token, information about node 103 and/or its user, or some other type of information associated with the token along with the token to perform validation. For instance, external system 107 may provide information about node 103 (e.g., an IP address of node 103) to identity provider 101 so identity provider 101 can ensure the token is associated with the same node to which identity provider 101 provided the token. Once the token is confirmed to be valid, external system 107 provides node 103 with access to external system 107 over communication network 106 (step 310).

External system 107, therefore, has authenticated node 103 for access thereto by virtue of node 103 being connected to private network 105 even though external system 107 is not part of private network 105. When using standard IDP authentication protocols, node 103, external system 107, and identity provider 101 simply need to comply with those protocols to successfully authenticate node 103 to external system 107. From the perspective of external system 107, it does not matter that identity provider 101 is a node on private network 105. External system 107 treats identity provider 101 like any other IDP external system 107 may be configured to use.

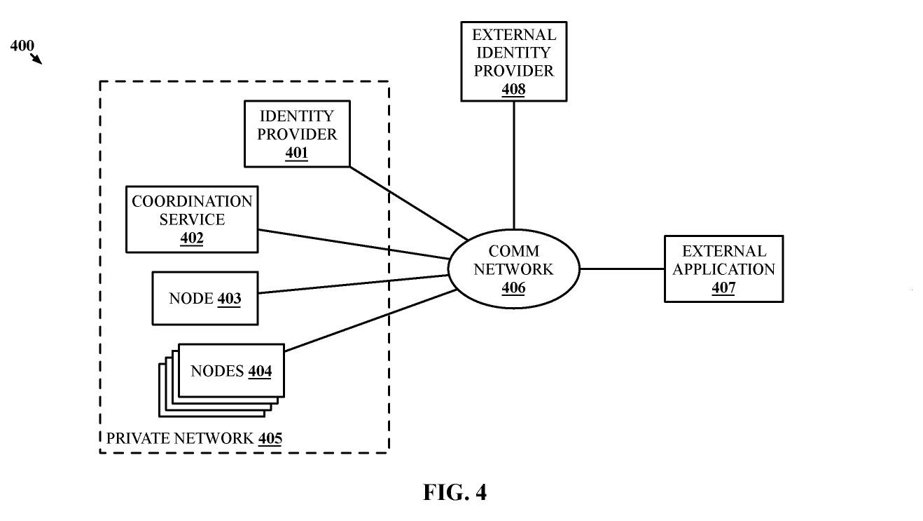

FIGS. 4 illustrates implementation 400 for authenticating a user to a resource using a private-network identity service. Implementation 400 includes identity provider 401, coordination service 402, nodes 403-404, private network 405, communication network 406, external application 407, and external identity provider 408. In this example, private network 405 is type of VPN which leverages the WireGuard protocol to provide secure, encrypted connections between devices over public networks, such as communication network 406. This type of VPN allows devices to communicate as if they were on the same local network, regardless of their physical location. Each device that joins private network 405 must authenticate itself via an identity provider, such as Google, Microsoft, or Okta, which ensures that only nodes associated with authorized users can connect to private network 105. The authentication process involves exchanging cryptographic keys, via coordination service 402 in this case, to establish trust between devices, ensuring that each node can securely identify and communicate with others within the network. Coordination service 402, therefore, acts as a control plane for private network 405. While shown within private network 405, coordination service 402 is not typically a node on private network 405. In some examples, coordination service 402 performs coordination tasks for multiple private networks, not just the single private network shown in this example.

Once authenticated, each device receives an IP address unique within the VPN from coordination service 402 and becomes part of private network 405. This IP address is used to route traffic securely within private network 405, and all communication is encrypted using the WireGuard protocol, although, other protocols may be used. Even if devices are on different underlying public networks, their data remains private and secure. Continuous authentication and authorization controls may also be implemented. This means devices are regularly verified and permissions can be adjusted dynamically. If a device’s status changes or if the identity provider's credentials are updated, private network 105 may enforce new access policies in real-time, maintaining the network's security and integrity.

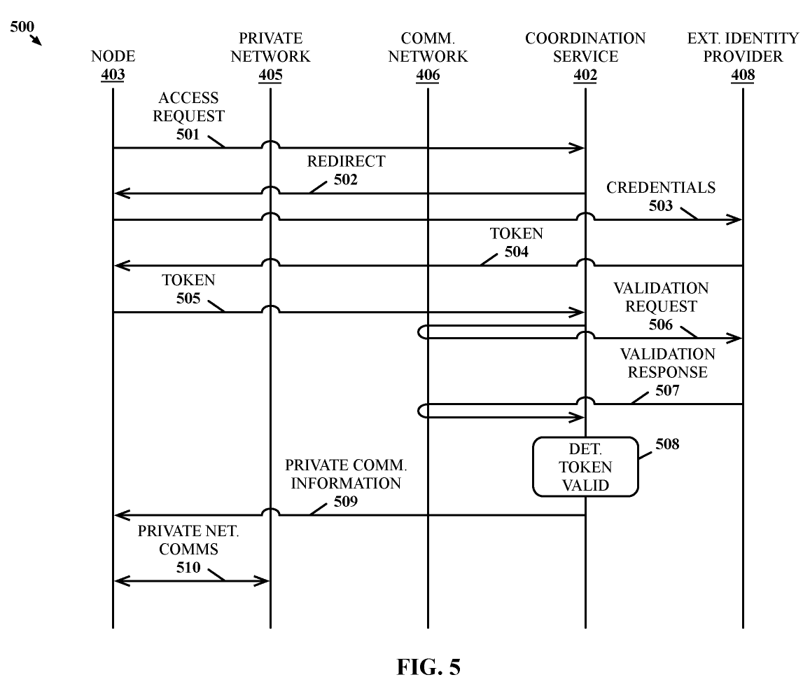

FIG. 5 illustrates operational scenario 500 for authenticating a user to a resource using a private-network identity service. Operational scenario 500 is an example of node 403 being authenticated for access to private network 405. Node 403 requests access to private network 405 by sending an access request to coordination service 402 over communication network 406 (step 501). Since node 403 is not yet authenticated to communicate over private network 405, node 403 uses an IP address of coordination service 402 on communication network 406 to direct the access request. A software process executing on node 403 to connect to and communicate over private network 405 may be tasked with determining the IP address of coordination service 402 (e.g., performing a DNS lookup for the address) if an IP address is not already known to the process.

Coordination service 402 manages connections and interactions between devices within private network 405. Coordination service 402 acts as a central authority that facilitates the initial authentication and ongoing management of nodes in private network 405. Beyond authentication, coordination service 402 may also help with routing and maintaining connectivity within private network 405. Coordination service 402 may track the current network topology and support the dynamic updating of device information, such as IP addresses and connection states. This ensures that devices can efficiently discover and communicate with each other, even as they move between different underlying networks or change their connection statuses. By centralizing these functions, coordination service 402 simplifies network management and enhances the overall security and reliability. Coordination service 402 may be implemented in a single computing device or may be distributed across multiple devices. In some examples, at least a portion of coordination service 402 may be distributed across one or more of nodes 403-404.

In response to receiving the access request, coordination service 402 transmits a redirect message to node 403 directing node 403 to contact external identity provider 408 for an authentication token (step 502). Node 403 responsively contacts external identity provider 408 and provides credentials (e.g., username, password, etc.) to external identity provider 408 to authenticate a user of node 403 (step 503). Communications with external identity provider 408 occur over communication network 406 because neither node 403 nor external identity provider 408 are nodes on private network 405. The credentials may be stored in node 403 or the user may enter the credentials into node 403 prior to being sent. If the credentials are accepted by external identity provider 408, external identity provider 408 transmits a token to node 403 (step 504). Node 403 forwards the token to coordination service 402 over communication network 406 (step 505)

Upon receiving the token from node 403, coordination service 402 requests validation of the token from external identity provider 408 over communication network 406 (step 506). In response to determining the token is valid, external identity provider 408 notifies coordination service 402 that the token is valid by sending a validation response over communication network 406 (step 507). Based on that validation response, coordination service 402 determines the token is valid and node 403 is allowed to access private network 405 on behalf of its authenticated user (step 508). In this example, coordination service 402 provides communication information for communicating with other nodes over private network 405 (step 509). The communication information may include private and public network addresses of the other nodes, encryption keys for the other nodes, or any other type of information that will enable node 403 to direct packets to other nodes on private network 405 and properly encrypt/decrypt those packets. As mentioned above, coordination service 402 may update the information as necessary (e.g., to add information about a new node that joins after node 403 received the information). Node 403 then uses the communication information to exchange communications with other nodes over private network 405 (step 510).

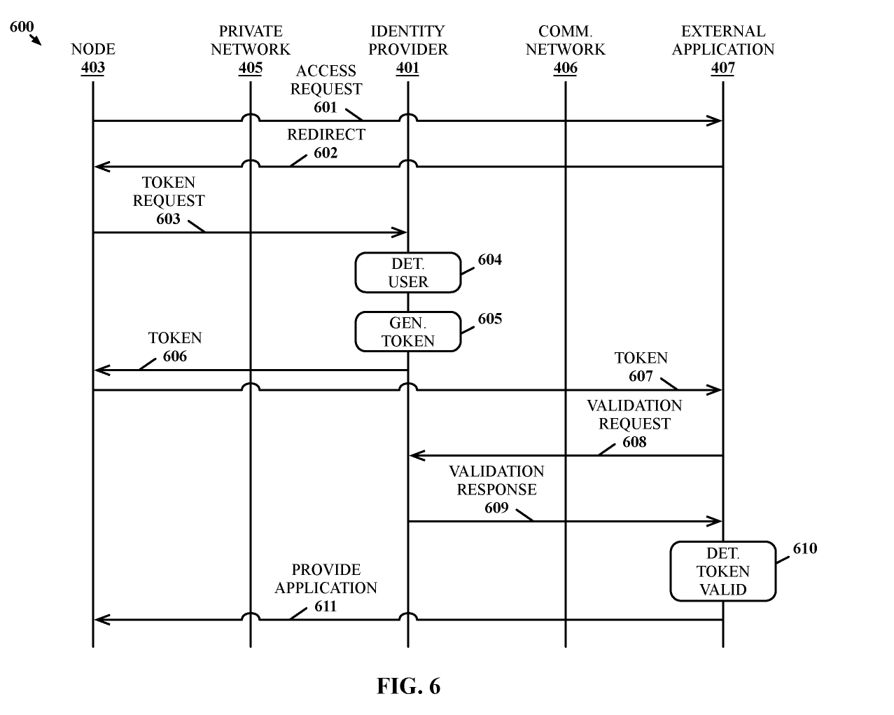

FIG. 6 illustrates operational scenario 600 for authenticating a user to a resource using a private-network identity service. Operational scenario 600 occurs after node 403 has been authenticated and joined to private network 405 in operational scenario 500. Node 403 requests access to external application 407 (step 601). External application 407 is an application (e.g., for data processing) provided by one or more computing systems external to private network 405. The access request to external application 407 is transmitted over communication network 406 because external application 407 is not a node on private network 405. External application 407 is, however, configured to use identity provider 401 for authentication on requests from private network 405. External application 407 transmits a redirect message to node 403 over communication network 406 directing node 403 to use identity provider 401 for authentication (step 602). In some examples, external application 407 may provide multiple options for authentication (e.g., via a user interface at node 403) and identity provider 401 may be selected (e.g., via user input or automatically by node 403) from those options.

Since identity provider 401 is a node on private network 405, node 403 requests a token over private network 405 (step 603). The token request is transmitted in one or more packets directed to a private address of identity provider 401 (e.g., an IP address of identity provider 401 on private network 405). The packets are encrypted using a public key assigned to identity provider 401 and encapsulated for transmission to a public address of identity provider 401 (e.g., an IP address of identity provider 401 on communication network 406). When identity provider 401 receives the packets, identity provider 401 decrypts the packets using a private key corresponding to the public key used to encrypt the packets. Since identity provider 401 knows the request was received from node 403, identity provider 401 may lookup information about the user of node 103 to determine whether the user is allowed to access external application 407 (step 604). Identity provider 401 does not have to reauthenticate the user. In this example, only a subset of the users authorized to access private network 405 may be authorized to access external application 407. Identity provider 401 may store the information about the user locally or may query another system, such as coordination service 402, for the information. In some examples, identity provider 101 may determine the user’s identity using a local identity resolution API (e.g., WhoIs) that inspects node 403’s connection metadata. This eliminates the need for explicit credential exchange during token issuance and ensures that identity is derived from the secure private-network session. For instance, a client executing on identity provider 401 for connecting to private network 405 may store network information (e.g., information provided by coordination service 402) for nodes on private network 405. This network information may include information about the user (e.g., name, username, role, etc.), address information (e.g., corresponding private and public IP addresses), encryption keys (e.g., public and private keys for encrypting packets for encapsulation), or another other information useful for coordinating communications over private network 405. Identity provider 401 may look up the user of node 403 in the network information associated with a private IP address from which the request was received. Coordination service 402 may provide identity provider 401 with grant information (or other form of access control) indicating which users are allowed access to which resources. Identity provider 401 may, therefore, reference the grant information to determine whether the user of node 403 is allowed access to external application 407.

Upon determining the user associated with node 403 and that the user can access external application 407, identity provider 401 generates a token for the user (step 605). The token may be generated using the same mechanism as external identity provider 408 used in operational scenario 500 or may be generated using a different mechanism or using different information.

Identity provider 401 transmits the token over private network 405 in a manner similar to that used by node 403 to transmit the token request (step 606). Node 403 then forwards the token to external application 407 over communication network 406 (step 607). Upon receiving the token, external application 407 requests validation of the token from identity provider 401 over communication network 406 (step 608). The validation request may transmit the token and indicate it was received from node 403. The determines the token is a valid token generated by identity provider 401 for use by node 403 and transmits a validation response indicating the validity to external application 407 (step 609). Based on the validation response, external application 407 determines the token is valid, which authenticates the user of node 403 to external application 407 (step 610). External application 407 then provides the application to node 403 over communication network 406 accordingly (step 611).

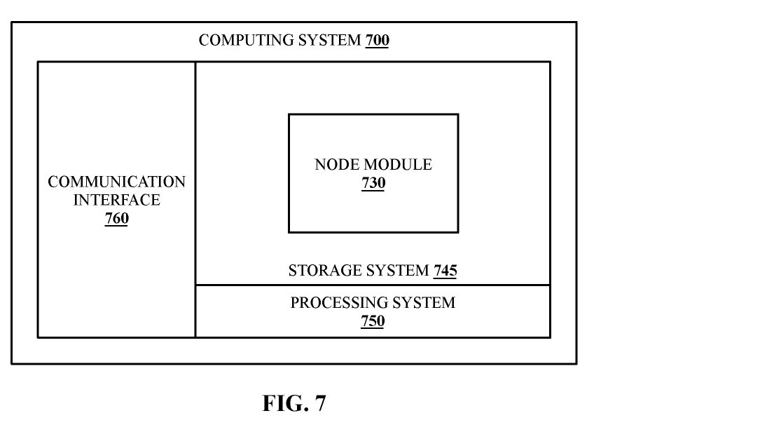

FIG. 7 illustrates computing system 700 for authenticating a user to a resource using a private-network identity service. Computing system 700 is representative of any computing system or systems with which the various operational architectures, processes, scenarios, and sequences disclosed herein can be implemented. Computing system 700 is an example architecture for identity provider 101, nodes 103-104, and external system 107, although other examples may exist. Computing system 700 includes storage system 745, processing system 750, and communication interface 760. Processing system 750 is operatively linked to communication interface 760 and storage system 745. Communication interface 760 may be communicatively linked to storage system 745 in some implementations. Computing system 700 may further include other components such as a battery and enclosure that are not shown for clarity.

Communication interface 760 comprises components that communicate over communication links, such as network cards, ports, radio frequency (RF), processing circuitry and software, or some other communication devices. Communication interface 760 may be configured to communicate over metallic, wireless, or optical links. Communication interface 760 may be configured to use Time Division Multiplex (TDM), Internet Protocol (IP), Ethernet, optical networking, wireless protocols, communication signaling, or some other communication format – including combinations thereof. Communication interface 760 may be configured to communicate with other computing systems via one or more networks.

Processing system 750 comprises microprocessor and other circuitry that retrieves and executes operating software from storage system 745. Storage system 745 may include volatile and nonvolatile, removable, and non-removable media implemented in any method or technology for storage of information, such as computer readable instructions, data structures, program modules, or other data. Storage system 745 may be implemented as a single storage device but may also be implemented across multiple storage devices or sub-systems. Storage system 745 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no interpretations would storage media of storage system 745, or any other computer-readable storage medium herein, be considered a transitory form of signal transmission (often referred to as "signals per se"), such as a propagating electrical or electromagnetic signal or carrier wave.

Processing system 750 is typically mounted on a circuit board that may also hold the storage system. The operating software of storage system 745 comprises computer programs, firmware, or some other form of machine-readable program instructions. The operating software of storage system 745 comprises node module 730. The operating software on storage system 745 may further include an operating system, utilities, drivers, network interfaces, applications, or some other type of software. When read and executed by processing system 750 the operating software on storage system 745 directs computing system 700 to network routing advertisements as described herein. Node module 730 may execute natively on processing system 750 or the operating software may include virtualization software, such as a hypervisor, to virtualize computing hardware on which node module 730 executes.

In at least one example, node module 730 executes on processing system 750 and directs processing system 750 to authenticate computing system 700 of a user to access the private network as a node thereon. Node module 730 further directs processing system 750 to transmit an access request from the node to an external system. The external system is external to the private network and is configured to use the identity provider to validate user identities. Node module 730 also directs processing system 750 to receive, at the node, a request from the external system for a token validating an identity of the user and request the token from the identity provider over the private network. The identity provider provides the token to the node on a basis of the user having already been authenticated for the node to access the private network. Also, node module 730 directs processing system 750 to transmit the token to the external system and the external system provides access to the node upon confirming with the identity provider that the token is valid.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method for operating an identity provider internal to a private network, the method comprising:
authenticating a node of a user to access the private network;
transmitting an access request from the node to a resource;
receiving, at the node, a request from the resource for a token validating an identity of the user;
at the node, requesting the token from the identity provider over the private network, wherein the identity provider provides the token to the node on a basis of the node having access to the private network; and
transmitting the token from the node to the resource, wherein the resource provides the node with access thereto upon confirming with the identity provider that the token is valid.

2. The method of claim 1, wherein authenticating the node includes:
providing user credentials of the user to a control plane for the private network; and
in response to the control plane validating the user credentials, receiving network information to access the private network.

3. The method of claim 2, wherein the network information includes private network addresses and encryption keys associated with other nodes on the private network.

4. The method of claim 1, wherein authenticating the node includes:
providing user credentials of the user to an external identity provider;
providing another token received from the external identity provider to a control plane of the private network; and
in response to the control plane validating the other token, receiving network information to access the private network.

5. The method of claim 1, comprising:
in the identity provider, identifying the user; and
determining the user is allowed to access the resource.

6. The method of claim 5, wherein determining the user is allowed to access the resource comprises:
referencing grant information received from a control plane of the private network, wherein the grant information indicates which users are authorized to access the resource.

7. The method of claim 1, wherein requesting the token from the identity provider over the private network comprises:
encapsulating a packet to create an encapsulated packet for the request using a public encryption key associated with the identity provider on the private network; and
sending the encapsulated packet to a public network address of the identity provider.

8. The method of claim 7, wherein the identity provider restores the packet from the encapsulated packet using a private encryption key corresponding to the public encryption key and identifies the user based on a source private network address of the node indicated in the packet.

9. The method of claim 1, wherein the identity provider ignores token requests not received over the private network.

10. An identity-provider system for a private network, the identity-provider system comprising:
one or more computer readable storage media;
one or more processing systems operatively coupled with the one or more computer readable storage media; and
program instructions stored on the one or more computer readable storage media that, when read and executed by the one or more processing systems, direct the identity-provider system to:
join the identity-provider system to the private network;
receive a token request from a node over the private network, wherein the token request is for a token validating a user of the node;
determine the token should be provided to the node based on the node being on the private network; and
transmit the token to the node over the private network, wherein the node uses the token to access a resource.

11. The identity-provider system of claim 10, wherein to join the identity-provider system to the private network, the program instructions direct the identity-provider system to:
provide credentials for accessing the private network to a control plane for the private network; and
in response to the control plane validating the credentials, receive network information to access the private network.

12. The identity-provider system of claim 11, wherein the network information includes private network addresses and encryption keys associated with nodes on the private network enabling the identity-provider system to communicate with the nodes over the private network.

13. The identity-provider system of claim 10, wherein to determine the token should be provided to the node, the program instructions direct the identity-provider system to:
identify a user of the node; and
determine the user is allowed to access the resource.

14. The identity-provider system of claim 13, wherein to determine the user is allowed to access the resource, the program instructions direct the identity-provider system to:
reference grant information received from a control plane of the private network, wherein the grant information indicates which users are authorized to access the resource.

15. The identity-provider system of claim 10, wherein the program instructions direct the identity-provider system to:
receive a second token request for the resource over the private network from a second node on the private network;
identify a second user of the second node; and
in response to determining the second user is not allowed to access the resource, deny the second token request.

16. The identity-provider system of claim 10, wherein to receive the token request, the program instructions direct the identity-provider system to:
obtain a packet carrying the token request from an encapsulated packet using a private encryption key corresponding to a public encryption key used by the node to encrypt the packet; and
identify the user based on a source private network address of the node indicated in the packet.

17. A method for operating an identity provider internal to a private network, the method comprising:
authenticating a node of a user to access the private network;
transmitting an access request from the node to an external system, wherein the external system is external to the private network and is configured to use the identity provider to validate user identities;
receiving, at the node, a request from the external system for a token validating an identity of the user;
at the node, requesting the token from the identity provider over the private network;
at the identity provider, providing the token to the node on a basis of the user having already been authenticated for the node to access the private network; and
transmitting the token from the node to the external system, wherein the external system provides access to the node upon confirming with the identity provider that the token is valid.

18. The method of claim 17, wherein requesting the token comprises:
encapsulating a packet carrying a token request and directed to a private network address of the identity provider; and
sending an encapsulation of the packet to a public network address of the identity provider.

19. The method of claim 17, wherein the identity provider provides the token on a further basis of the user being allowed to access the external system.

20. The method of claim 17, comprising:
in the identity provider, prior to the node requesting the token, receiving access grant information from a control plane of the private network, wherein the access grant information indicates which nodes on the private network are allowed to access the external system.
